(19) United States
(12) Patent Application Publication
(10) Pub. No.: US 2009/0210692 A1
(43) Pub. Date: Aug. 20, 2009

(54) Method for encoding data in a network used in process automation systems

(75) Inventors: Detlev Wittmer, Maulbronn (DE); Martin Gehrke, Weinstadt (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta GmbH + Co. KG, Gerlingen (DE)

(21) Appl. No.: 10/585,820

(22) PCT Filed: Dec. 15, 2004
(86) PCT No.: PCT/EP04/53519

§ 371 Date: Aug. 25, 2008

(30) Foreign Application Priority Data
Jan. 12, 2004 (DE) 102004001755.7

(51) Int. Cl. H04L 29/02

(52) U.S. Cl. 713/150

(57) ABSTRACT

In a method for encrypting data in a network of process automation technology, the data are encrypted in a control unit, which is connected with the network, in a separate, exchangeable software module.

The invention relates to a method of encryption of data in a network of process automation technology.

In the technology of process automation, field devices are often employed, which serve for measuring and/or influencing process variables. Examples of such field devices are fill level measuring devices, mass flow measuring devices, pressure and temperature measuring devices, pH redox potential measuring devices, conductivity measuring devices, etc., which register as sensors the corresponding process variables, fill level, flow, pressure, temperature, pH value, and conductivity, respectively.

Besides such pure measuring devices, known also are systems, which have yet other responsibilities. Mentionable here are electrode cleaning systems, calibration systems, as well as sample takers.

Likewise referred to as field devices are input/output units—so called remote I/Os.

Serving for influencing process variables are so-called actuators, e.g. valves which control the flow of a liquid in a section of pipeline or pumps which change the fill level in a container.

A multitude of such field devices are manufactured and sold by the firm Endress+Hauser®.

Frequently, field devices are connected with superordinated units, e.g. control systems or control units, via a fieldbus (Profibus®, Foundation®-Fieldbus, HART®, etc.). These superordinated units serve for process control, process visualization, process monitoring, as well as for interacting with the field devices.

For interacting with the field devices, corresponding operating programs (operating tools) are needed in the control system or control unit. These operating programs can run on their own or they can also be integrated into control system applications.

A limited interaction with field devices is possible with conventional, often-used device-descriptions.

For a comprehensive interacting with the field devices, all functions and parameters, including the graphic operating elements, must be made known to the operating program (operating tool).

Device manufacturers are, therefore, now delivering for their field devices, device drivers, e.g. DTMs (device type managers), which encapsulate all data and functions of the particular field device and, at the same time, provide a graphical user interface.

With the help of these device drivers, a device- and manufacturer-transparent interaction with field devices is possible with an operating program.

The device drivers require, as runtime environment, a frame application. Frame applications enable access to various data of the field devices (e.g., device parameters, measured values, diagnosis information, status information, etc.).

These data are, as a rule, transmitted unencrypted via the fieldbus and, as required, further communication networks. This means that this data exchange is not secure against misuse. Unauthorized persons who have access to the communication connection between control unit and field device can tamper with the field devices without the plant operator learning of such.

This is very problematic, especially as regards process safety. The larger the communication network via which the data are transmitted, the greater is the danger of unauthorized accesses.

This holds, above all, when also public networks are needed for the data transmission.

An object of the invention is, therefore, an easily executable and cost favorable method for encrypting data in a network of process automation technology.

This object is achieved by the features as defined in claim 1.

Advantageous further developments of the invention are presented in the dependent claims.

An essential idea of the invention is that the data exchanged via a communication network of process automation technology are encrypted in the control unit with the help of a separate, exchangeable software module.

In a further development of the invention, the software module is embodied as a device type manager DTM according to the FDT specifications. In this way, the software module can be easily integrated into known FDT frame applications (PACTware®, Field Care®, etc.).

The FDT specifications, in terms of an industrial standard, were developed by PNO (Profibus® User Organisation) in cooperation with ZVEI (Zentralverband Elektrotechnik-und Elektronikindustrie—i.e., the German Electrical and Electronic Manufacturers' Association). The current FDT specification 1.2 is available from ZVEI.

With the help of the software module of the invention, it is possible quickly and simply to install new encryption algorithms without extensive reprogramming being needed, e.g., for the operating tool.

The invention will now be explained in greater detail on the basis of examples of embodiments presented in the drawing, the figures of which show as follows:

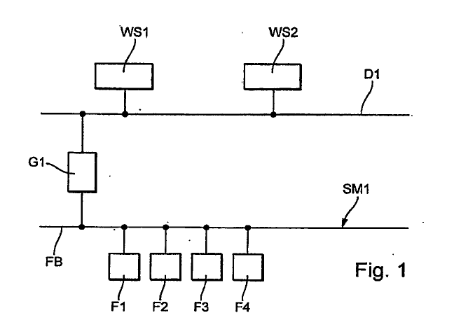

FIG. 1 schematic drawing of a process automation network containing a plurality of field devices; and

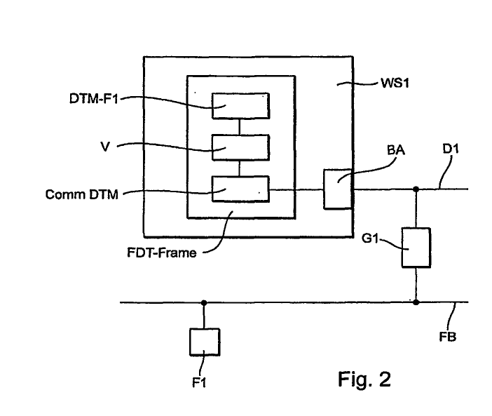

FIG. 2 schematic drawing of a communications connection to a field device.

FIG. 1 shows a process-automation communications-network. Connected to a databus D1 are a plurality of computer units (work stations) WS1, WS2. These computer units serve as superordinated units (control system or control units) for process visualization, process monitoring and for engineering, as well as for interacting with and monitoring field devices. Databus D1 works, e.g., according to the Profibus® DP standard or according to the HSE (High Speed Ethernet) standard of Foundation® Fieldbus. Via a gateway 1, which is referred to as a linking device or as a segment coupler, databus D1 is connected with a field bus segment SM1. The field bus segment SM1 is formed by a plurality of field devices F1, F2, F3, F4, which are connected together via a field bus FB. The field devices F1, F2, F3, F4 can be both sensors and actuators. Field bus FB works according to one of the known field bus standards Profibus, Foundation Fieldbus or HART.

FIG. 2 shows, schematically, an operating program, which runs on one of the control units WS1, WS2, or on someother interaction unit, such as a laptop or a hand-held. The operating program can be the operating software PACTware (PACTware Consortium e.V.) or FieldCare® (of the firm Endress+Hauser®), which both require, as the operating system, Microsoft Windows® 98NT or 2000 and which serve as FDT-frame-applications. The FDT-frame-application is, especially, responsible for managing the DTMs in a project database, for the communications to the bus systems, for the managing of the device catalogs, as well as for the managing of the users and access rights, etc.

Running in the FDT frame application are: A device DTM, DTM-F1; an encryption DTM, V; and a communications DTM, Comm DTM. The device DTM, DTM-F1, which is also referred to as a device driver, encapsulates the data and functions of the field device F1 and requires, as run time environment, the FDT frame application. With the help of this DTM, a device- and manufacturer-transparent[interaction with the field device F1 is possible. Especially, the DTM-F1 allows access to device parameters, device configuration, downloading of diagnostic data and status information via a manufacturer-specific, graphical user interface.

The FDT concept is based on the fact that different field device DTMs of different manufacturers can be integrated into a FDT frame application in simple manner.

With respect to hardware, the connection is accomplished via a bus connection BA, the database D1, the gateway G1, the field bus FB to the field device F1.

The functioning of the invention will now be explained in greater detail.

In the encryption DTM, V, which is embodied as an independent software module, the data, which is exchanged between the operating program and the field device, are encrypted.

Via the encapsulated functions of the device DTMs, DTM-F1, parameters can be changed in the field device F1. The data needed for this are encrypted in the encryption DTM V with a corresponding algorithm and transmitted via the databus D1 and the field bus FB to the field device F1. In the field device F1, the data are unencrypted and the corresponding commands executed.

Because the data are encrypted in a separately exchangeable software module, a simple adapting to new encryption methods is possible. To accomplish this, only the corresponding software module V needs to be exchanged.

1. A method for encryption of data in a process automation network, including a network connected control unit, comprising the step of:
encrypting data in the network-connected control-unit, in a separate, exchangeable software module.

2. The method as claimed in claim 1, wherein:
the software module meets the FDT/DTM standard.

3. The method as claimed in claim 1, further comprising the step of:
providing an FDT frame application, which runs in the control unit which serves as runtime environment for the software module.
